(19) United States
(12) Patent Application Publication
(10) Pub. No.: US 2009/0323588 A1
(43) Pub. Date: Dec. 31, 2009

(54) SIGNALING FOR MULTI-USER REUSING ONE SLOT (MUROS) OPERATION IN GSM

(75) Inventors: Behrouz Aghili, Commack, NY (US); Marian Rudolf, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/407,530

(22) Filed: Mar. 19, 2009

Related U.S. Application Data
(60) Provisional application No. 61/037,824, filed on Mar. 19, 2008.

(51) Int. Cl. H04W 4/00

(52) U.S. Cl. 370/328

(57) ABSTRACT

Methods and apparatus for improved Multiple Users Reusing One Slot (MUROS) operation include two or more wireless transmit/receive units (WTRU) multiplexed onto multiple sub-channels in a single timeslot. Addressing information included in layer two headers, Radio Resource Control (RRC) messages, and layer one parameters in a SACCH/FACCH transmission indicate that the transmission is intended for a particular WTRU. A FACCH transmission may be sent on a sub-channel reserved for another WTRU. Stealing bits in a voice frame may be set to indicate that the FACCH transmission is intended for a WTRU on the sub-channel reserved for another WTRU. Different WTRUs in a multiplexed group may be configured to decode layer one parameters in a SAACH according to alternating patterns.

### TECHNICAL FIELD

This disclosure relates to wireless communications.

### BACKGROUND

Various approaches have been developed to allow multiple users to reuse a single timeslot in time slotted wireless systems, referred to as Multiple Users Reusing One Slot (MUROS) technologies. One such approach involves the use of orthogonal sub-channels (OSC). The OSC concept allows a wireless network to multiplex two wireless transmit/receive units (WTRUs) that are allocated the same radio resource (that is, time slot). In the uplink direction, the sub-channels are separated using non-correlated training sequences. The first sub-channel uses existing training sequences, and the second sub-channel uses new training sequences. Alternatively, only new training sequences may be used on both of the sub-channels. Using OSC enhances voice capacity with negligible impact to WTRUs and networks. OSC may be transparently applied for all Gaussian minimum shift keying (GMSK) modulated traffic channels (for example, for full rate traffic channels (TCH/F), half rate traffic channels (TCH/H), a related slow associated control channel (SACCH), and a fast associated control channel (FACCH)).

OSC increases voice capacity by allocating two circuit switched voice channels (that is, two separate calls) to the same radio resource. By changing the modulation of the signal from GMSK to QPSK (where one modulated symbol represents two bits), it is relatively easy to separate two users—one user on the X axis of the QPSK constellation and a second user on the Y axis of the QPSK constellation. A single signal contains information for two different users, each user allocated their own sub-channel.

In the downlink, OSC is realized in a base station (BS) using a quadrature phase shift keying (QPSK) constellation that may be, for example, a subset of an 8-PSK constellation used for enhanced general packet radio service (EGPRS). Modulated bits are mapped to QPSK symbols (“dibits”) so that the first sub-channel (OSC-0) is mapped to the most significant bit (MSB) and the second sub-channel (OSC-1) is mapped to the least significant bit (LSB). Both sub-channels may use individual ciphering algorithms, such as A5/1, A5/2 or A5/3. Several options for symbol rotation may be considered and optimized by different criteria. For instance, a symbol rotation of 3π/8 would correspond to EGPRS, a symbol rotation of π/4 would correspond to π/4-QPSK, and a symbol rotation of π/2 can provide sub-channels to imitate GMSK. Alternatively, the QPSK signal constellation can be designed so that it appears like a legacy GMSK modulated symbol sequence on at least one sub-channel.

An alternate approach of implementing MUROS in the downlink involves multiplexing two WTRUs by transmitting two individual GMSK-modulated bursts per timeslot. As this approach causes increased levels of inter-symbol interference (ISI), an interference-cancelling technology such as Downlink Advanced Receiver Performance (DARP) Phase I or Phase II is required in the receivers. Typically, during the OSC mode of operation, the BS applies downlink and uplink power control with a dynamic channel allocation (DCA) scheme to keep the difference of received downlink and/or uplink signal levels of co-assigned sub-channels within, for example, a ±10 dB window, although the targeted value may depend on the type of receivers multiplexed and other criteria. In the uplink, each WTRU may use a normal GMSK transmitter with an appropriate training sequence. The BS may employ interference cancellation or joint detection type of receivers, such as a space time interference rejection combining (STIRC) receiver or a successive interference cancellation (SIC) receiver, to receive the orthogonal sub-channels used by different WTRUs.

OSC may or may not be used in conjunction with frequency-hopping or user diversity schemes, either in the downlink (DL), in the uplink (UL), or both. For example, on a per-frame basis, the sub-channels may be allocated to different pairings of users, and pairings on a per-timeslot basis may recur in patterns over prolonged period of times, such as several frame periods or block periods.

It has been further proposed that statistical multiplexing may be used to allow more than two WTRUs to transmit using two available sub-channels. For example, four WTRUs may transmit and receive speech signals over a 6-frame period by using one of two sub-channels in assigned frames.

When a WTRU is assigned to a traffic channel (TCH), the corresponding control channel is either the slow associated control channel (SACCH) or the fast associated control channel (FACCH). The corresponding SACCH data appears once in every 26-frame Global System for Mobile Communications (GSM) multiframe. The FACCH operates, on the other hand, by substituting FACCH data in a speech frame. Presence of the FACCH is indicated by setting the stealing flags in the bursts to 1. Accordingly, WTRUs decode the SACCH by decoding at the predefined frame number in the multiframe. WTRUs decode the FACCH by checking stealing flags and then decoding when the values of the stealing flag are set to one.

In current GSM implementations, only one WTRU is assigned to receive data in a particular timeslot. Because a SACCH or FACCH is sent on a particular timeslot, only one WTRU will receive the SACCH or FACCH data. Even where half-rate (HR) transport channels are used, the corresponding SACCHs are mapped according to predetermined rules such that they are received by only one of the two WTRUs receiving data on the TCH. According to current approaches, when a WTRU decodes a SACCH or FACCH on a given burst, the control information itself does not include an indication that the control information is intended for that WTRU or for another WTRU that shares the same timeslot resource.

Additionally, it may sometimes be desirable to send the FACCH or SACCH to a WTRU using a resource that is typically assigned to a different WTRU on the same resource. This is because stealing a regular voice frame to transmit a FACCH message may have a negative impact on voice quality. When, however, the other WTRU is in discontinuous transmission (DTX), stealing from the other WTRU's sub-channel will not have an impact on voice quality. Additionally, it may be desirable to send a message to a WTRU using a SACCH that belongs to another WTRU. It may be possible, for example, for a WTRU to receive a Short Message Service (SMS) message on a SACCH belonging to another WTRU. However, current technology does not provide a mechanism to identify a FACCH frame or SACCH frame as addressed to a particular WTRU.

Therefore, an approach is desired to identify and associate FACCH and SACCH messages to WTRUs in the context of MUROS.

### SUMMARY

Methods and apparatus for improved Multiple Users Reusing One Slot (MUROS) operation include two or more wireless transmit/receive units (WTRUs) multiplexed onto multiple sub-channels in a single timeslot. Addressing information included in layer two headers, Radio Resource Control (RRC) messages, and layer one parameters in a SACCH/FACCH transmission indicate that the transmission is intended for a particular WTRU. A FACCH transmission may be sent on a sub-channel reserved for another WTRU. Stealing bits in a voice frame may be set to indicate that the FACCH transmission is intended for a WTRU on the sub-channel reserved for another WTRU. Different WTRUs in a multiplexed group may be configured to decode layer one parameters in a SAACH according to alternating patterns.

### BRIEF DESCRIPTION OF THE DRAWINGS

A more detailed understanding may be had from the following description, given by way of example in conjunction with the accompanying drawings wherein:

FIG. 1 is a functional block diagram of a WTRU and a base station (BS);

FIG. 2 shows an example format of an Address field in a layer two header of a FACCH or SACCH message;

FIG. 3 shows transmission of data on the FACCH or SACCH indicating a recipient WTRU in the context of MUROS;

FIG. 4 shows an example of a WTRU receiving a FACCH on a sub-channel reserved for another WTRU;

FIG. 5 shows layer one parameters sent to the WTRUs in an OSC pair in alternating SACCH frames; and

FIG. 6 shows unused space in a layer one parameter used to indicate an intended recipient WTRU of a SACCH transmission.

### DETAILED DESCRIPTION

When referred to herein, the terminology “wireless transmit/receive unit (WTRU)” includes but is not limited to a user equipment (UE), a mobile station, a fixed or mobile subscriber unit, mobile station (MS), a pager, a cellular telephone, a personal digital assistant (PDA), a computer, or any other type of user device capable of operating in a wireless environment. When referred to herein, the terminology “base station” includes but is not limited to a Node-B, a site controller, an access point (AP), or any other type of interfacing device capable of operating in a wireless environment.

The subject matter disclosed herein is applicable to all realizations of the MUROS concept. They are applicable to, for example, approaches that use: (1) orthogonal sub-channels (OSCs) multiplexed signals by means of modulation, including QPSK modulation; (2) signals relying on interference-cancelling receivers which employ, for example, Downlink Advanced Receiver Performance (DARP) technology; and (3) a combination of OSC and signals relying on interference-cancelling receivers. Additionally, although examples may be provided indicating a particular modulation type, the principles described herein may equally be applied to other modulation types, including GMSK (Guassian Minimum Shift Keying), 8-Phase Shift Keying (PSK), 16-Quadrature Amplitude Modulation, 32-QAM, and other modulation types.

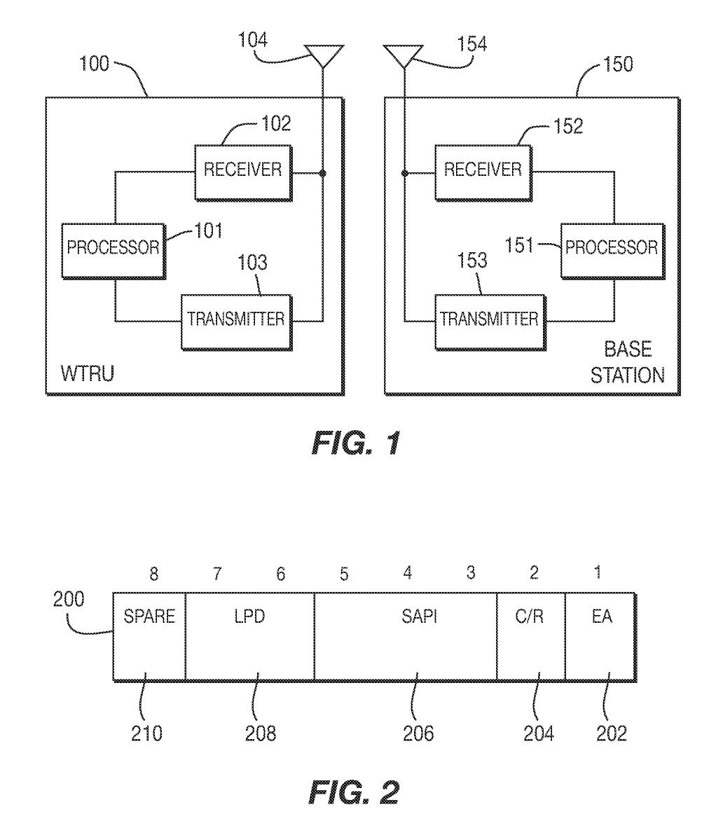

FIG. 1 is a functional block diagram of a WTRU 100 and a base station (BS) 150 configured in accordance with the disclosed embodiments. The WTRU 100 includes a processor 101 in communication with a receiver 102, transmitter 103, and antenna 104. The BS 150 includes a processor 151 in communication with a receiver 152, transmitter 153, and antenna 154. The WTRU 100 may include additional transmitters and receivers (not depicted) in communication with the processor 101 and antenna 104 for use in multi-mode operation, as well as other components described below. The WTRU 100 may include additional optional components (not depicted) such as a display, keypad, microphone, speaker, or other components.

FIG. 2 shows an example format of an Address field octet 200 in a layer two header of a FACCH or SACCH message. In layer three, messages in the SACCH and FACCH are sent using the Data Link Layer protocol (LAPDm). LAPDm operates in either acknowledged mode (AM) or unacknowledged mode (UM). In both modes, messages sent on the FACCH and SACCH in the downlink include a layer two header that includes an Address field, a Control field, and a Length Indicator field. Referring to FIG. 2, bit one of the Address field octet 200 is an extended address (EA) bit 202. Bit two is a command/response (C/R) bit 204. Bits three to five are service access point identifier (SAPI) bits 206. Bits six and seven are Link Protocol Discriminator (LPD) bits 208. The most significant bit (bit eight) is a spare bit 210.

The spare bit 210 may be used to distinguish between two WTRUs that are multiplexed onto a timeslot. During a resource assignment, registration, or other set up procedure, the network may indicate to the WTRUs which of the WTRU corresponds to “0” and which of the WTRUs corresponds to “1” in the spare bit 210. This may be performed using, for example, an Assignment Command, Handover Command, DTM Assignment Command, or other assignment, registration, or resource allocation message. Alternatively, pre-defined rules may be used to define a correspondence between values in the spare bit 210 and the intended recipient WTRU. For example, correspondences may be used between MUROS sub-channels, user transmission/reception patterns, FACCH/SACCH occurrences, frame or sequence numbers, timer or counter values, or other identifiers or codes. For example, where OSC is used, a “0” value in the spare bit 210 may correspond to OSC sub-channel zero and a “1” value may correspond to sub-channel one, or vice versa.

As shown in FIG. 2, LPD information is indicated in two LPD bits 208. However, according to current GSM standards, there are only two possible code points defined for LPD information in this context. This leaves the second of the two LPD bits 208 (bit seven in the Address field octet 200) unused. Bit six of the address field octet 200 may be used to indicate a recipient WTRU, as described above with respect to the spare bit 210. Alternatively, the spare bit 210 and the unused bit of the two LPD bits 208 may be used in combination to carry an identifier. Alternatively, unused code point or field values in the SAPI bits 206, C/R bits 204, and/or any other portions of the Address field octet 200 may be used to carry bits of the identifier.

In a two sub-channel MUROS implementation, a single bit may be sufficient to identify a WTRU. However, more than one bit may be used. Additionally, in an OSC implementation which provides than two sub-channels through the use of 16-Quadrature Amplitude Modulation (QAM), user diversity multiplexing, or some other mechanism, two bits may be used to identify associations involving up to four sub-channels with the FACCH or SACCH. This may be accomplished using bits seven and eight of the Address field octet 200, or by using the spare bit 210 as identified above, or by using a combination of other bits. For example, in the two bits that are used, values 0-3 may correspond to OSC sub-channels 0-3. Alternatively, the correspondences between WTRUs and identifier values may be signaled or implicit based on pre-defined rules as described above with OSC involving two sub-channels. A different identifier or association of a WTRU or sub-channel or sub-channel group can be used for the SACCH and for the FACCH. Alternatively, they may be the same.

Radio resource control (RRC) messages sent on the FACCH or SACCH may include an indicator of the recipient WTRU. For example, an identifier regarded as a “sub-channel MUROS Id” may be used. An RRC message may include a one-bit Information Element (IE) that serves to identify the recipient WTRU. Alternatively, the IE may use two bits or more than two bits. For example, where more than two OSC sub-channels are used, an IE that includes two or more bits may be used. Alternatively, the identifier may be realized by a spare bit or bits or code points, or a combination thereof, in an RRC message carried on the FACCH or SACCH. The correspondence between values in the RRC messages and OSC sub-channels may be sent to WTRUs during a resource assignment, registration, or other set up procedure, or may be established using implicit rules as described above. RRC messages sent on the FACCH which may include the indicator of the recipient WTRU include but are not limited to the ASSIGNMENT COMMAND, HANDOVER COMMAND, and DTM HANDOVER COMMAND messages. RRC messages sent on the SACCH which may include the indicator of the recipient WTRU include but are not limited to the SYSTEM INFORMATION TYPE 5bis, SYSTEM INFORMATION TYPE 5ter, SYSTEM INFORMATION TYPE 6, and MEASUREMENT INFORMATION messages.

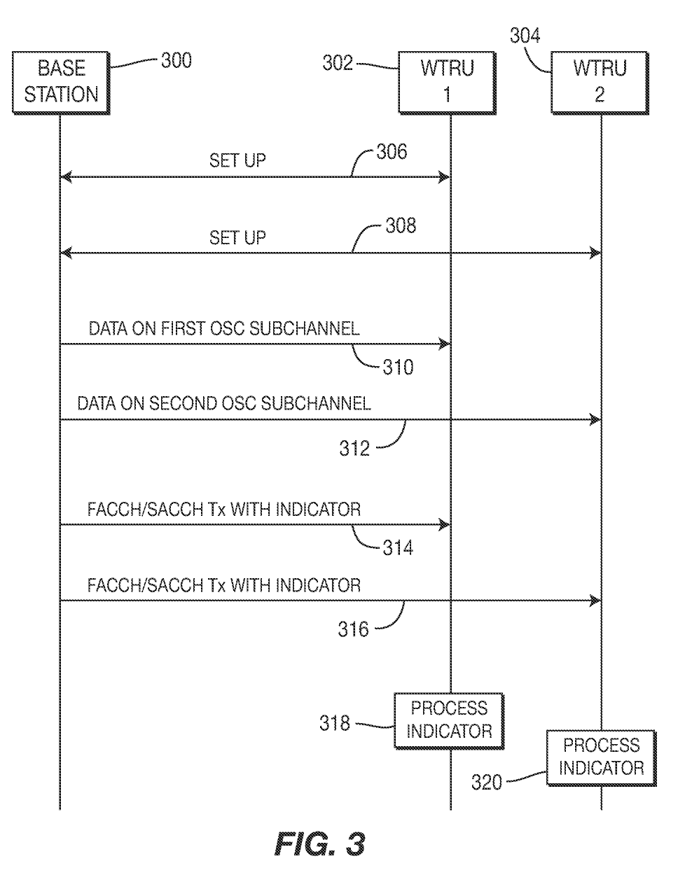

FIG. 3 shows the transmission of control data on the FACCH or SACCH indicating a recipient WTRU in the context of MUROS. FIG. 3 shows a base station (BS) 300 in communication with a first WTRU 302 and a second WTRU 304. The first WTRU performs 306 a resource assignment, registration, or other set up procedure as described above. The second WTRU 304 performs 308 a similar procedure. Performance 306, 308 of the set up procedures may involve communication of signals from the BS 300 to the WTRUs 302, 304 as described above, the signals indicating a correspondence between the WTRUs and identifiers that will correspond to the WTRUs 302, 304 in subsequent SACCH/FACCH transmissions. The first WTRU 302 receives data 310 from the BS 300 on a first OSC sub-channel in a timeslot. The second WTRU 304 receives data 312 from the BS 300 on a second OSC sub-channel in the timeslot. The BS 300 generates a FACCH or SACCH transmission as described above and sends the transmission 314, 316 to both the first WTRU 302 and the second WTRU 304. The FACCH or SACCH transmission contains an indicator of the intended recipient WTRU. The indicator may be included in a layer two header, RRC message, or other message according to any of the embodiments as described above. The first WTRU 302 processes 318 the FACCH/SACCH transmission to determine, based on the indicator, if the transmission is intended for the first WTRU 302. The second WTRU 304 processes 320 the FACCH/SACCH transmission in a similar fashion. If either of the WTRUs determines that they are the intended recipient of the FACC/SACCH transmission, they react accordingly to reconfigure their operational state as indicated by the control information in the FACCH/SACCH transmission.

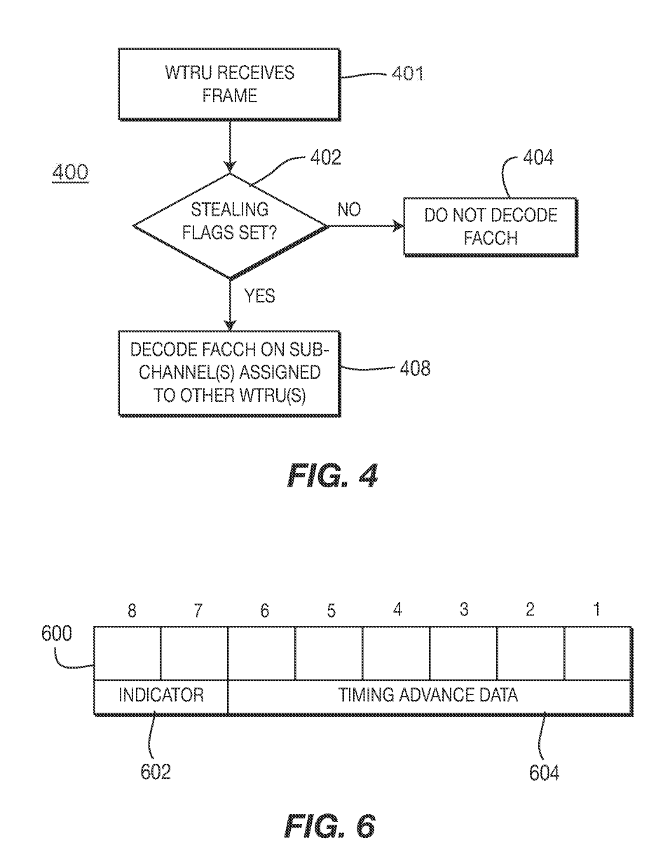

FIG. 4 is a flow diagram of a method 400 for a WTRU to receive a FACCH on a sub-channel reserved for another WTRU. The WTRU receives 401 a frame. The frame may be a voice frame or a FACCH control frame. The WTRU analyzes 402 the frame to check if stealing flags are set to indicate a FACCH transmission. If the stealing flags are not set, the WTRU does not decode 404 for a FACCH transmission. If the stealing flags are set to indicate a FACCH transmission, then the WTRU decodes 408 the FACCH transmission on sub-channels of one or more WTRUs with which it is multiplexed. Alternatively, the WTRU may decode the FACCH transmission on its own sub-channel as well as the sub-channel of one or more other WTRUs.

Stealing flags may indicate not only the presence of the FACCH, but also which OSC sub-channel the FACCH is carried on. For example, where QPSK or 16-QAM is used, the two stealing flag bits may indicate an OSC sub-channel based on the following organization: “00” indicates a speech frame; “01” indicates a FACCH on a first OSC sub-channel; and “11” indicates a FACCH on a second OSC sub-channel.

Alternatively, rules may be defined to determine when a FACCH for a first WTRU may be carried on the sub-channel allocated for a second WTRU. For example, to search for a FACCH addressed to it by decoding a second WTRU's sub-channel at every Nth occurrence or according to a pre-determined assignment pattern.

Additionally, where multi-frame structures for individual WTRUs or groups of WTRUs are offset compared to those corresponding to other OSC sub-channels, a WTRU may decode SACCH transmissions on the other OSC sub-channels to determine if a message for it is carried there.

An identifier indicating a recipient WTRU of a SACCH or FACCH message may be realized in layer one, layer two, or layer three messages, used individually or in combination. For example, a portion of an identifier may be carried in layer two, while another portion of the identifier may be carried in layer three. As a more specific example, a stealing flag may indicate the presence of the FACCH to a WTRU, and/or indicate a sub-channel on which the FACCH should be received. The FACCH message itself may then also include an indicator according to any of the embodiments described above that identifies the WTRU as the recipient.

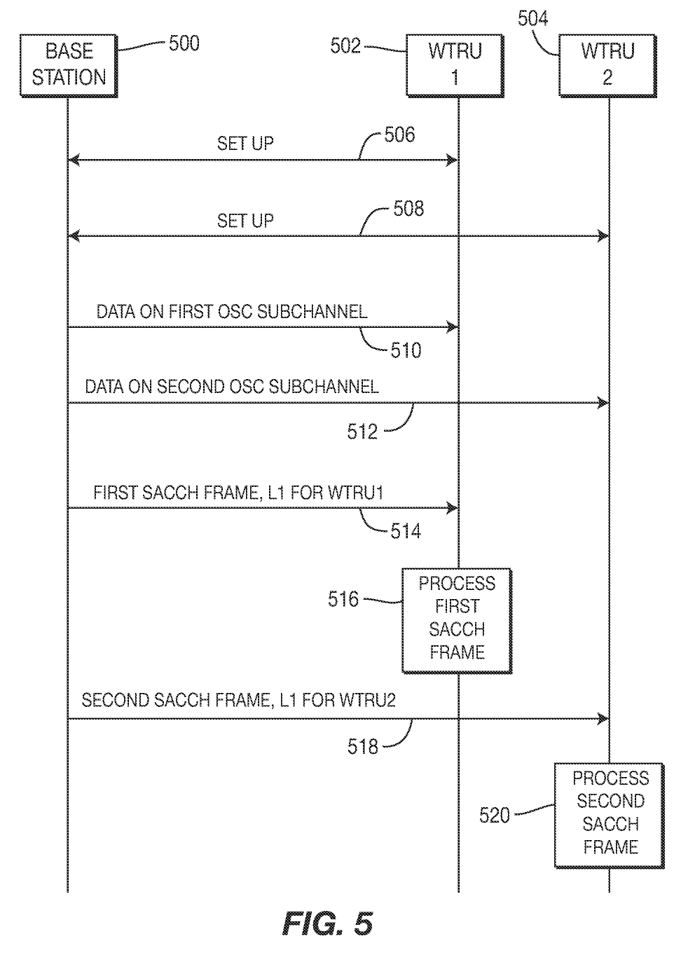

FIGS. 5 and 6 show approaches to sending control information targeted at a WTRU in the context of OSC using layer one parameters. In the DL, a BS transmits System Information messages to WTRUs over the majority of the SACCH lifetime. In most instances, the layer three information included in the System Information message is the same for all of the WTRUs multiplexed on a same timeslot using OSC. However, there are also two layer one parameters (the Timing Advance (TA) and the Power Command) that are sent in the LAPDm frames used for SACCH. These two parameters are appended as two octets by layer one onto the LAPDm frames for SACCH. Therefore, although the layer three contents of the System Information messages can be the same for multiple WTRUs multiplexed onto a timeslot, the layer one parameters may be different for the different WTRUs.

FIG. 5 shows layer one parameters sent to the WTRUs in an OSC pair in alternating SACCH frames. The first WTRU 502 performs 506 a resource assignment, registration, or other set up procedure to coordinate communications with the base station 500. The second WTRU 504 performs 508 a similar procedure. Performance 506, 508 of the set up procedures may involve the transmission of signals from the BS 500 to the WTRUs 502, 504 for coordinating the reception and interpretation of layer one parameters as described in further detail below. For example, the set up procedures may involve data transmitted from the BS 500 to the WTRUs 502, 504 indicating that SACCH frames will include layer one parameters for the two WTRUs 502, 504 on an alternating basis. The first WTRU 502 receives data 510 from the BS 500 on a first OSC sub-channel in a timeslot. The second WTRU 504 receives data 512 from the BS 500 on a second OSC sub-channel in the timeslot. The BS 500 generates a first SACCH transmission containing layer one parameters such as the Timing Advance and Power Control parameters as described above, with the intended recipient being the first WTRU, and the frame is received 514 by the first WTRU 502. The first WTRU 502 processes 516 the control data in the frame including the layer one parameters and reacts accordingly. The second WTRU may or may not also receive and process the first SACCH frame (not depicted), though it will be configured to ignore the layer one parameters included in the frame. The BS 500 generates the next SACCH frame to contain layer one parameters intended for the second WTRU 504 and transmits 518 the second SACCH frame. The second SACCH frame is received and the layer one parameters are processed 520 by the second WTRU 504, and the second WTRU 504 reacts accordingly. The second SACCH frame may or may not be received and processed by the first WTRU (not depicted), but the first WTRU will be configured to ignore the layer one parameters included in the frame. This method may then continue, with alternating SACCH transmissions including layer one parameters for the two WTRUs 502, 504.

In addition to alternating SACCH transmissions as shown in FIG. 5, the SACCH transmissions may be sent according to various other orders and transmission patterns. As shown in FIG. 5, the rules for associations between the orders of the SACCH and the intended recipients may be signaled during a set up procedure as described in FIG. 5. Alternatively, the rules may be derived implicitly based on known parameters.

Further, a rule associating a particular SACCH occurrence with either a single WTRU or group may be used. For example, a first WTRU may decode against the SACCH at predetermined occurrences, but will disregard the layer one parameters received at these occurrences because they are intended for a second WTRU. The first WTRU also decodes against the SACCH at other predetermined occurrences, but does act on the layer one parameters received at these other occurrences. The sets of predetermined occurrences may or may not overlap.

FIG. 6 shows a Timing Advance Parameter octet 800 wherein previously unused space is employed to indicate an intended recipient WTRU of a SACCH transmission. In the current GSM standards, the value of a Timing Advance parameter can range from zero to sixty-three. Therefore, six bits are required to express all of the possible used values of a Timing Advance parameter. However, in current implementations, an entire octet is reserved to indicate the value of the Timing Advance parameters. Therefore, the two extra bits may be used to indicate an intended recipient WTRU of the SACCH transmission, and one of the extra two bits or both of the extra two bits may be used. Referring to FIG. 6, a Timing Advance parameter octet 600 includes bits one through eight. A first portion 604 (including bits one through six) used to store timing advance data values, and can indicate the values zero to sixty-three. A second portion 602 (including bits seven and eight) may be used to indicate values zero through three, and these values may correspond to different intended recipient target WTRUs. Similar to the Timing Advance parameter, the Power Command parameter is also allocated an entire octet but the entire octet is not used, and so the same principles as shown in FIG. 6 may be applied to the Power Command parameter.

Alternatively, the bits currently allocated to Power Command and Timing Advance parameters may be re-organized to indicate information relating to more than one WTRU. In the current technology, many implementations do not set the value of a Timing Advance parameter to be greater than two. Values for zero, one, and two can be represented with two bits, leaving six bits unused. Accordingly, the eight bits allocated to the Timing Advance parameter may be divided and used to indicate different timing advance values for two recipient WTRUs. For example, the octet may be split into two groups of four bits each. The first four bits may then represent a Timing Advance parameter value for a first WTRU and the second four bits may represent a Timing Advance parameter for a second WTRU. The same principles may also be applied to Power Command octets.

Alternatively, a base station may send a single SACCH transmission that is decoded by multiple WTRUs that are multiplexed onto a timeslot, where one particular SACCH occurrence is used, but where different layer one contents are sent individually to each WTRU.

The layer one parameters as described above may alternatively be included in messages that are sent using GMSK as opposed to QPSK, as there is only one transmission per burst when GMSK is used. Alternatively, QPSK may be used but a lower output power may be required because the layer three information is the same for more than one WTRU.

Additionally, an indicator may be included encoded in layer one in a message to indicate that the contents of the message correspond to common SACCH or FACCH contents that are intended to be decoded by more than one WTRU. Alternatively, the indicator may indicate that the contents of the SACCH or FACCH transmission are intended for all sub-channel users or a subset of the sub-channel users on the burst. The indicator may be, for example, a bit flag or may be allocated multiple bits.

Occurrences of the SACCH may be predefined to carry common messages applicable to more than one WTRU multiplexed on a timeslot. For example, alternating transmission of a SACCH may be reserved for common messages. According to this approach, a base station can send a SACCH or FACCH transmission containing layer three information intended for more than one multiplexed WTRU, saving on transmission bandwidth and increasing link robustness.

Referring again to FIG. 1, the processors 101, 151 are configurable to generate, encode, and decode the messages and signals described above with reference to FIGS. 2-6. The transmitters 103, 153 and receivers 102, 152 are configurable to send and receive, respectively, the messages and signals as described above with reference to FIGS. 2-6.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless transmit/receive unit (WTRU), comprising:
a receiver configured to receive a frame on an orthogonal sub-channel (OSC) on a slow associated control channel (SACCH) or a fast associated control channel (FACCH), the frame including an indicator identifying an intended recipient of the frame; and
a processor configured to determine if the WTRU is the intended recipient of the frame based on the indicator.

2. The WTRU of claim 1 wherein the receiver is further configured to receive a configuration message indicating associations between indicator values and intended recipients and wherein the processor is configured to determine if the WTRU is the intended recipient of the frame based on the associations.

3. The WTRU of claim 2 wherein the configuration message is an assignment message or registration message.

4. The WTRU of claim 2 wherein the associations include mappings from the indicator values to OSC sub-channels and wherein the processor is configured to determine if the WTRU is the intended recipient of the frame based on the indicator and the OSC on which the receiver is configured to receive data.

5. The WTRU of claim 1 wherein the indicator is included in an Address field in a layer two header in the frame.

6. The WTRU of claim 5 wherein the indicator is a seventh bit of the Address field.

7. The WTRU of claim 5 wherein the indicator is an eighth bit of the Address field.

8. The WTRU of claim 1 wherein the indicator is included in a Radio Resource Control (RRC) message in the frame.

9. The WTRU of claim 8 wherein the RRC message is an ASSIGNMENT COMMAND, HANDOVER COMMAND, DTM HANDOVER COMMAND, SYSTEM INFORMATION TYPE 5bis, SYSTEM INFORMATION TYPE 5ter, SYSTEM INFORMATION TYPE 6, or MEASUREMENT INFORMATION message.

10. The WTRU of claim 8 wherein the indicator is an Information Element (IE).

11. The WTRU of claim 1 wherein the indicator is included in a layer one parameter.

12. The WTRU of claim 11 wherein the layer one parameter is a Power Command or Timing Advance parameter.

13. The WTRU of claim 11 wherein the layer one parameter is an octet, and wherein the indicator is included in the seventh and eighth bits of the octet.

14. A wireless transmit/receive unit (WTRU), comprising:
a receiver configured to receive data on a first orthogonal sub-channel (OSC) assigned to the WTRU and to receive a message including an indicator indicating that the WTRU should decode a fast access control channel (FACCH) on a target OSC.

15. The WTRU of claim 14 wherein the message is a voice frame and the indicator is one or more stealing flags.

16. The WTRU of claim 14 wherein the target OSC is a second orthogonal sub-channel assigned to a second WTRU.

17. The WTRU of claim 14 wherein the target OSC is the first OSC.

18. A wireless transmit/receive unit (WTRU) comprising:
a receiver configured to receive data on an orthogonal sub-channel (OSC) and to receive a slow associated access channel (SACCH) transmission; and
a processor configured to determine if the WTRU is an intended recipient of layer one contents of the SACCH transmission based on a SACCH reception rule.

19. The WTRU of claim 18 wherein the SACCH reception rule indicates that the WTRU is the intended recipient of alternating SACCH transmissions.

20. The WTRU of claim 18 wherein the receiver is further configured to receive the SACCH reception rule in a registration or assignment procedure.
